(19) United States
(12) Patent Application Publication
(10) Pub. No.: US 2025/0073786 A1
(43) Pub. Date: Mar. 6, 2025

(54) BIT CENTERING CHUCK ASSEMBLY

(71) Applicant: MILWAUKEE ELECTRIC TOOL CORPORATION, Brookfield, WI (US)

(72) Inventors: James Wekwert, Whitefish Bay, WI (US); Kyle Reeder, Waukesha, WI (US)

(21) Appl. No.: 18/696,690

(22) PCT Filed: Oct. 24, 2022
(86) PCT No.: PCT/US2022/047546

§ 371 Date: Mar. 28, 2024

Related U.S. Application Data
(60) Provisional application No. 63/282,745, filed on Nov. 24, 2021.
(60) Provisional application No. 63/275,145, filed on Nov. 3, 2021.

(51) Int. Cl. B23B 31/12

(52) U.S. Cl. CPC B23B 31/1238; B23B 31/123; B23B 2231/26; B23B 2260/12; B23B 2260/146

(57) ABSTRACT

A chuck assembly for use with a rotary power tool. The chuck assembly includes a chuck body, a plurality of jaws, and a plate. The chuck body has a plurality of passageways, a plurality of jaws, and a plate. The plurality of jaws are each received within one of the plurality of passageways for co-rotation with the chuck body about the axis, each of the jaws comprises a groove extending in a direction perpendicular to the axis and along a first radial side, an inner side, and a second radial side of the jaw. The plate comprises a plurality of notches, each notch receiving the groove of one of the plurality of jaws to couple the plate to the plurality of jaws, the plate moving with the plurality of jaws to set an axial stop for the tool bit.

### CROSS-REFERENCE TO RELATED APPLICATIONS

This application claims priority to U.S. Provisional Application No. 63/275,145, filed on Nov. 3, 2021, and entitled “Bit Centering Chuck Assembly”, and to U.S. Provisional Application No. 63/282,745, filed on Nov. 24, 2021, and entitled “Bit Centering Chuck Assembly”, the contents of which are hereby incorporated by reference in their entirety.

### FIELD OF THE INVENTION

The present invention relates to tool chucks, and more particularly to chucks that help center tool bits.

### SUMMARY

In one aspect, the invention provides a chuck assembly for use with a rotary power tool, the chuck assembly comprising a chuck body rotatable about an axis, the chuck body including a plurality of passageways, a plurality of jaws, and a plate. The plurality of jaws are each received within one of the plurality of passageways for co-rotation with the chuck body about the axis, each comprise a tip end and an opposite tool end, a first radial side and a second radial side, an outer side and an opposite inner side, the inner side facing the axis, each of the jaws comprising a groove extending in a direction perpendicular to the axis and along the first radial side, the inner side, and the second radial side. The plate comprises a plurality of notches, each notch receiving the groove of one of the plurality of jaws, to couple the plate to the plurality of jaws, the plate moving with the plurality of jaws to set an axial stop for the tool bit.

In some aspects, the invention provides a chuck assembly for use with a rotary power tool, the chuck assembly comprising a chuck body rotatable about an axis, the chuck body including a plurality of passageways and a plurality of jaws. The plurality of jaws are each received within one of the plurality of passageways for co-rotation with the chuck body about the axis, each comprise a tip end and an opposite tool end, a first radial side and an opposite second radial side, an outer side and an opposite inner side, the inner side facing the axis, each jaw comprising a mating feature configured to mate with the mating feature of an adjacent one of the plurality of jaws.

In some aspects, the invention provides a chuck assembly for use with a rotary power tool to secure a tool bit to the rotary power tool, the chuck assembly comprising a chuck body rotatable about an axis, the chuck body including a plurality of passageways, a plurality of jaws, and an indicator. The plurality of jaws are each received within one of the plurality of passageways for co-rotation with the chuck body about the axis and each of the plurality of jaws comprises a tip end and an opposite tool end, a first radial side and an opposite second radial side, an outer side and an opposite inner side, the inner side facing the axis. The indicator is configured to indicate to a user a status of the plurality of jaws on the tool bit upon sufficient rotation of the chuck body to secure the plurality of jaws to the tool bit above a threshold force.

In some aspects, the invention provides a chuck assembly for use with a rotary power tool to secure a tool bit to the rotary power tool, the chuck assembly comprising a chuck body rotatable about an axis, the chuck body including a plurality of passageways, a plurality of jaws, and an indicator. The plurality of jaws are each received within one of the plurality of passageways for co-rotation with the chuck body about the axis and each of the plurality of jaws comprises a tip end and an opposite tool end, a first radial side and an opposite second radial side, an outer side and an opposite inner side, the inner side facing the axis. The indicator is configured to indicate to a user locations of the plurality of jaws.

Other aspects of the invention will become apparent by consideration of the detailed description and accompanying drawings.

### BRIEF DESCRIPTION OF THE DRAWINGS

FIG. 1 is a perspective view of a chuck assembly in a deployed position.

FIG. 2 is a perspective view of the chuck assembly of FIG. 1 in a retracted position.

FIG. 3 is a perspective view of the chuck assembly of FIG. 1 with a chuck body thereof hidden.

FIG. 4 is another perspective view of the chuck assembly of FIG. 1 with the chuck body thereof hidden.

FIG. 5 is an exploded view of the chuck assembly of FIG. 1.

FIG. 6 is a front view of the chuck assembly of FIG. 1 in the deployed position.

FIG. 7 is a front view of the chuck assembly of FIG. 1 in the retracted position.

FIG. 8 is a cross-sectional view of the chuck assembly taken along section line 8-8 in FIG. 6.

FIG. 9 is a cross-sectional view of the chuck assembly taken along section line 9-9 in FIG. 7.

FIG. 10 is a cross-sectional view of the chuck assembly taken along section line 10-10 in FIG. 6.

FIG. 11 is a cross-sectional view of the chuck assembly taken along section line 11-11 in FIG. 7.

FIG. 12 is a perspective view of a jaw of the chuck assembly.

FIG. 13 is another perspective view of the jaw of FIG. 12.

FIG. 14A is a front view of the jaw of FIG. 12.

FIG. 14B is a rear view of the jaw of FIG. 12.

FIG. 15A is a side view of the jaw of FIG. 12.

FIG. 15B is another side view of the jaw of FIG. 12.

FIG. 16A is a top view of the jaw of FIG. 12.

FIG. 16B is a bottom view of the jaw of FIG. 12.

FIG. 17 is a perspective view of a plate of the chuck assembly.

FIG. 18 is an end view of the plate of FIG. 17.

FIG. 19 is a perspective view of a chuck assembly including a lock indicator mechanism.

FIG. 20 is a perspective cross-sectional view of the lock indicator mechanism of FIG. 19.

FIG. 21 is a perspective view of the lock indicator mechanism of FIG. 20 in an unlocked position.

FIG. 22 is a perspective view of the lock indicator mechanism of FIG. 20 in a locked position.

FIG. 23 is a front view of a tool bit properly engaged with a chuck assembly.

FIG. 24 is a front view of a tool bit improperly engaged with a chuck assembly.

FIG. 25 is another front view of a tool bit improperly engaged with a chuck assembly.

FIG. 26 is a first perspective view of a chuck assembly including a jaw indicator mechanism.

FIG. 27 is a second perspective view of the chuck assembly and jaw indicator mechanism of FIG. 26.

FIG. 28 is a front view of the chuck assembly and jaw indicator mechanism of FIG. 26.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

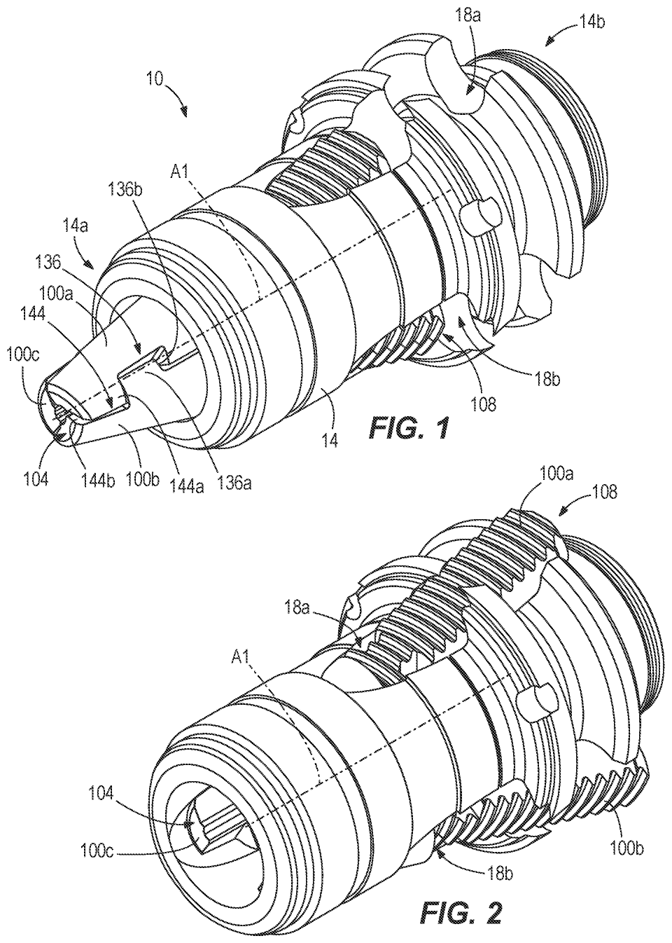

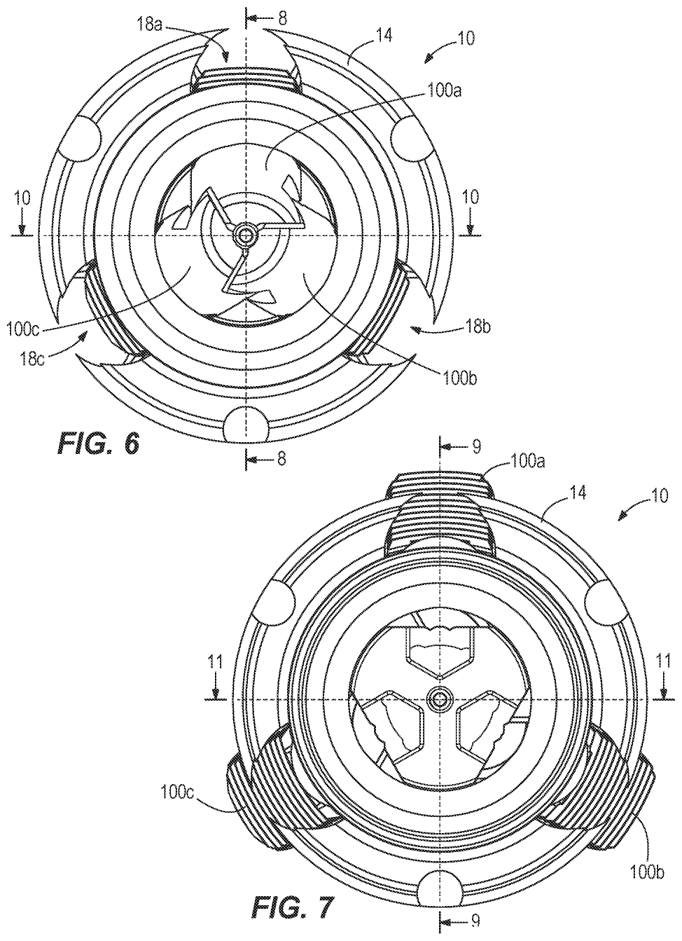

FIG. 1 illustrates a chuck assembly 10 for use with, for example, a power tool. The chuck assembly 10 includes a chuck body 14 which is rotatable about an axis A1 (i.e., a central axis). The chuck body 14 is generally annular in shape and extends from a tip end 14a to a tool end 14b. The chuck body 14 includes a plurality of passageways 18a, 18b, 18c (FIG. 6) (i.e., the passageways 18) extending therethrough. The tool end 14b of the chuck body 14 is configured to be coupled to a rotary power tool (e.g., a drill/driver) for rotation about the axis A1. The chuck assembly 10 further includes a plurality of jaws 100a, 100b, 100c (i.e., the jaws 100). Each of the plurality of jaws 100 is received within a corresponding one of the plurality of passageways 18 for co-rotation with the chuck body 14 about the axis A1. Each jaw 100 includes a tip end 104 and an opposite tool end 108. FIG. 1 illustrates the chuck assembly 10 with the jaws 100 in a deployed position in relation to the chuck body 14. In this position, the tip end 104 of the jaws 100 protrudes axially (i.e., in a direction parallel to the axis A1) beyond the tip end 14a of the chuck body 14.

FIG. 2 illustrates the chuck assembly 10 with the jaws 100 in a retracted position in relation to the chuck body 14. In the retracted position, the tip end 104 of the jaws 100 is received axially (i.e., in a direction parallel to the axis A1) within the annular chuck body 14 between the tip end 14a and the tool end 14b thereof. In the retracted position, the tool end 108 of the jaws 100 is further received within the passageways 18 at a position radially further from the axis A1 when compared to the deployed position of FIG. 1.

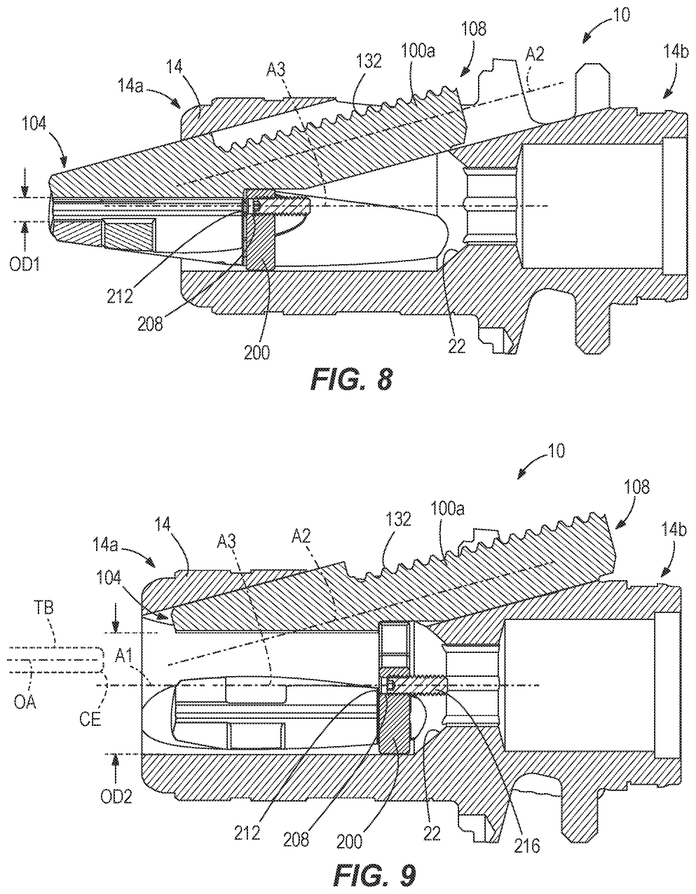

The chuck assembly 10 is movable between the deployed position (FIG. 1) and the retracted position (FIG. 2) by rotation of a tightening sleeve in contact with the jaws 100. Rotation of the tightening sleeve may cause the jaws 100 to axially translate in a direction parallel to the axis A1 and simultaneously may cause the jaws A1 to radially translate in a direction perpendicular to the axis A1. As illustrated in FIGS. 8 and 9, the passageway 18a extends along an axis A2 which is angled at an angle A3 relative to the axis A1. The other passageways 18b, 18c also are provided at the angle A3 relative to the axis A1. The angle A3 in the illustrated embodiment is about 15 degrees. In other embodiments, other angles A3 are possible. Upon rotation of the tightening sleeve, the jaws 100 are translated along the axis A2 between the deployed position (FIGS. 1, 8) and the retracted position (FIGS. 2, 9). Accordingly, the jaws 100 can be moved to engage tool bits with different outer dimensions perpendicular to the axis A1. In some embodiments, the jaws 100 may be operable to engage tool bits with outer dimensions OD1 (FIG. 8), OD2 (FIG. 9) between about 0.158 centimeters (0.0625 inches) and about 1.27 centimeters (0.5 inches), respectively. However, the chuck assembly 10 may be otherwise sized to engage tool bits with other outer dimensions. The tool bits may include, for example, driver bits, drill bits, and the like.

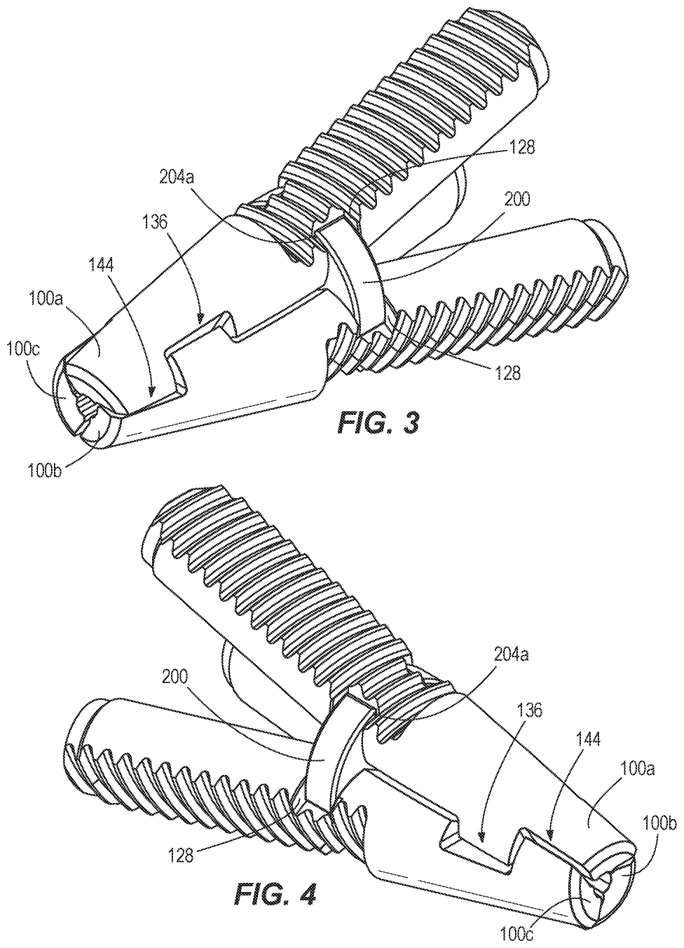

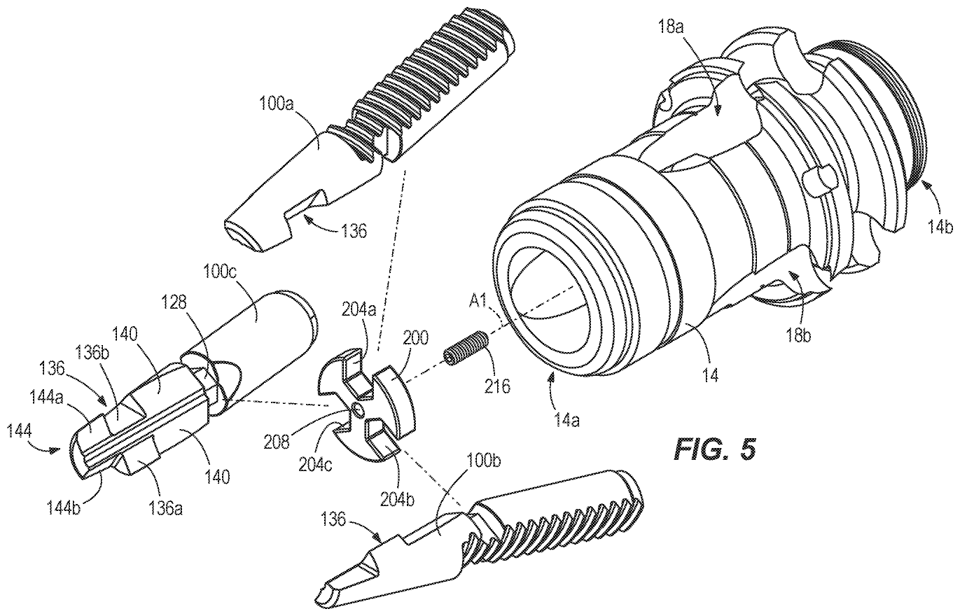

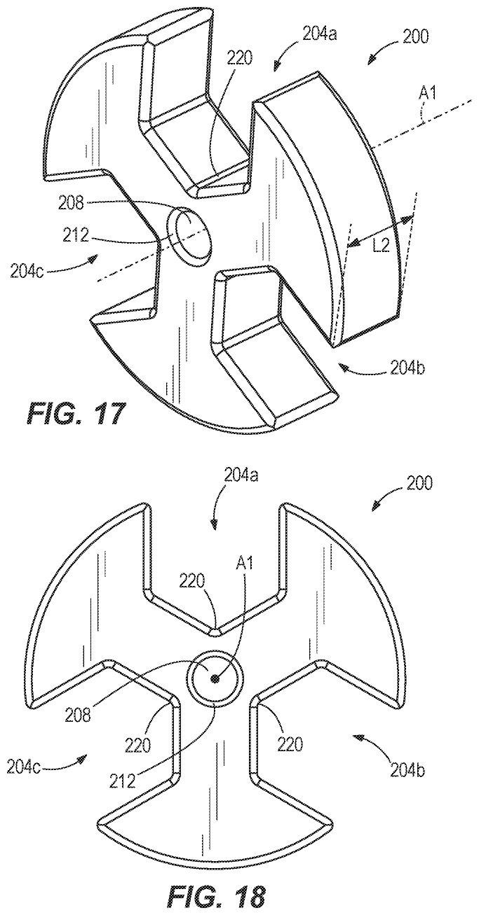

FIGS. 3 and 4 illustrate the chuck assembly 10 with the chuck body 14 hidden. As illustrated in FIGS. 3 and 4, each jaw 100 includes a groove 128. The chuck assembly 10 further includes a plate 200 (FIG. 5). The plate 200 comprises a plurality of notches 204a, 204b, 204c (also shown in FIGS. 17 and 18) (i.e., the notches 204). Each of the notches 204 receives one of the grooves 128 of one of the jaws 100. The coupling between the notches 204 and the grooves 128 couples the axial position of each of the plurality of jaws 100 to each other in an axial direction parallel to the axis A1. Accordingly, the jaws 100 are inhibited from axial deflection relative to each other.

FIG. 5 illustrates an exploded view of the chuck assembly 10. In addition to the chuck body 14, the jaws 100, and the plate 200. The chuck assembly 10 further includes a set screw 216. The set screw 216, or other fastener or projection, may be coupled to the plate 200, and may couple the plate 200 to the power tool.

FIG. 8 illustrates the chuck assembly 10 in the deployed position, and FIG. 9 illustrates the chuck assembly 10 in the retracted position. As illustrated in both FIGS. 8 and 9, the plate 200 is movable along with the jaws 100 in an axial direction parallel to the axis A1. With reference to FIG. 8, the plate 200 is inhibited from axial removal from the tip end 14a of the chuck body 14 as the tip ends 104 of the jaws 100 contact each other in the deployed position. With reference to FIG. 9, excess axial movement of the plate 200 towards the tool end 14b is inhibited when the translation of the jaws 100 parallel to the axis A1 cause the plate 200 to contact a frustoconical interior surface 22 of the chuck body 14. As illustrated in both FIGS. 8 and 9, the set screw 216 may be coupled to one axial end of the plate 200, and the other axial end of the plate 200 may be uninhibited. In sum, each notch 204a-204c of the plate 200 receives a groove 128 of one of the plurality of jaws 100a-100c to couple the plate 200 to the plurality of jaws 100a-100c. Due to the interconnected grooves 128 and notches 204a-204c, the plate 200 moves along the axis A1 with the plurality of jaws 100a-100c as the jaws 100a-100c move along corresponding axes A2 of each jaw 100a-100c. The plate 200 (more specifically, the end of the plate 200 which faces the tip end 14a) sets an axial stop for the tool bit TB to inhibit over-insertion of the tool bit TB into the chuck assembly 10. As shown in FIG. 8, the jaw 100a is relatively close to the center of the chuck body 14, and the plate 200 is positioned relatively close to the tip end 14a of the chuck body 14. Accordingly, smaller length and cross-sectional sized tool bits TB may be held in the position illustrated in FIG. 8. As shown in FIG. 9, the jaw 100a is relatively far from the center of the chuck body (i.e., the axis A1), and the plate 200 is positioned relatively far from the tip end 14a of the chuck body 14. Accordingly, larger length and cross-sectional sized tool bits TB may be held in the position illustrated in FIG. 9.

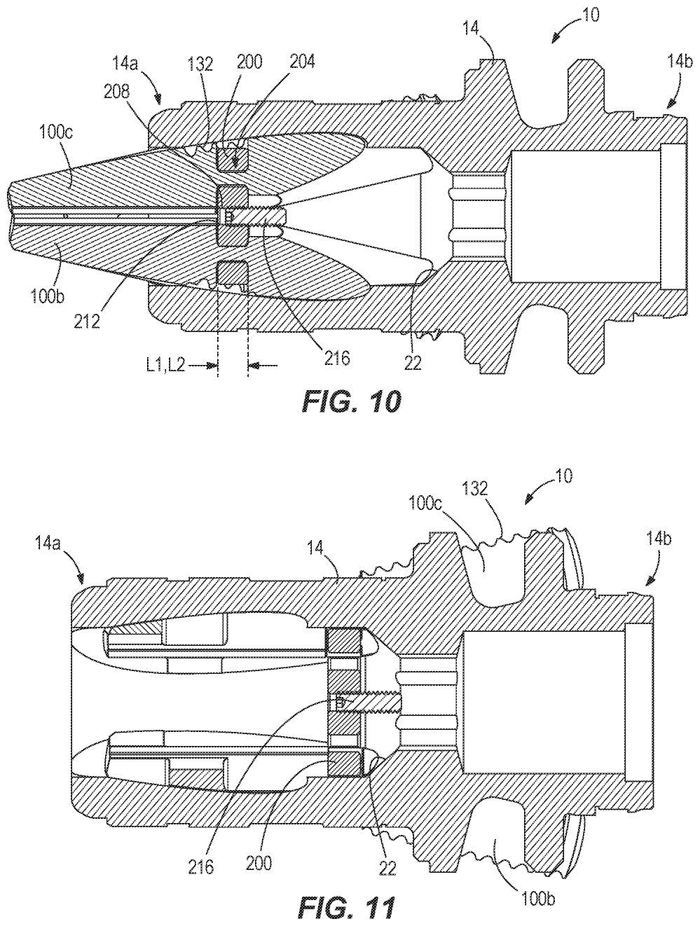

FIG. 10 illustrates the chuck assembly 10 in the deployed position, and FIG. 11 illustrates the chuck assembly 10 in the retracted position. As illustrated in FIG. 10, the notches 204 of the plate 200 are received in corresponding grooves 128 of the jaws 100. As illustrated in FIG. 11, the jaws 100 may be retracted from the plate 200 in a direction away from and perpendicular to the axis A1. However, in the retracted position, the grooves 128 and the notches 204 remain in radial alignment with each other such that as the jaws 100 are moved from the retracted position (FIG. 11) towards the deployed position (FIG. 10), the jaws 100 are translated axially forward and radially inwardly towards the axis A1 with the notches 204 engaging the grooves 128.

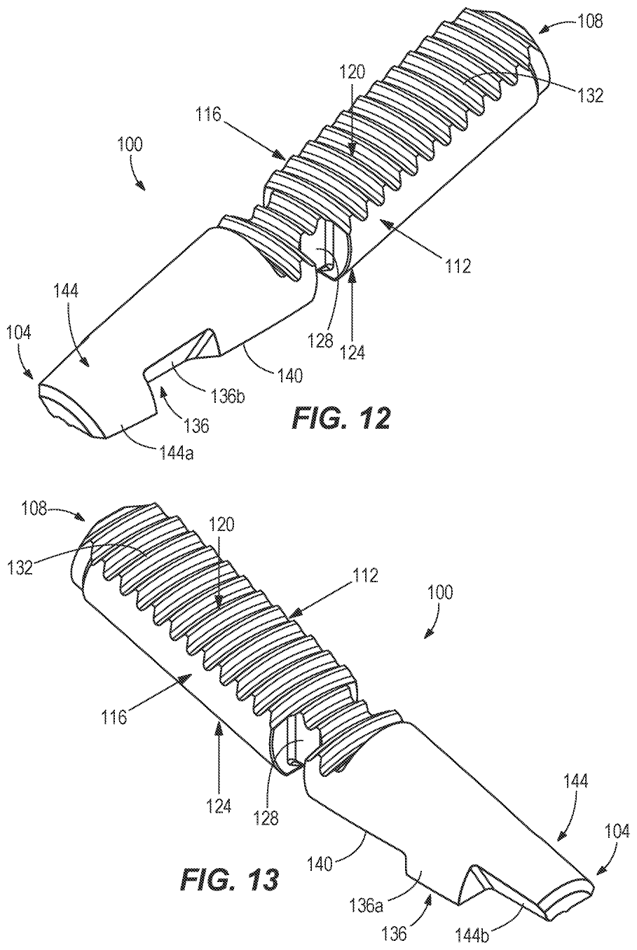

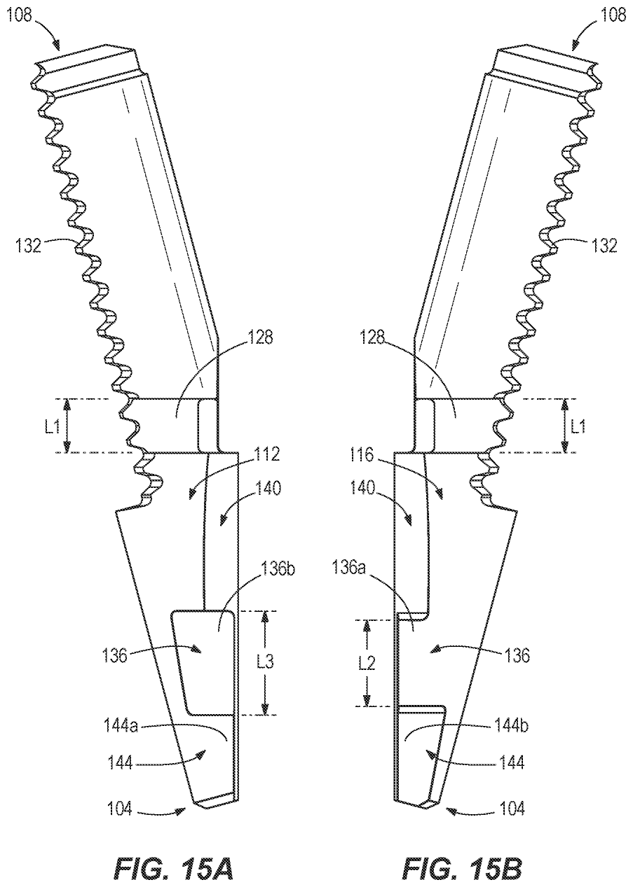

FIGS. 12-16B illustrate the jaws 100 alone. As previously mentioned, each jaw 100 includes a tip end 104 and an opposite tool end 108. Each jaw 100 further includes a first radial side 112 and an opposite second radial side 116. Each jaw 100 further includes an outer side 120 facing away from the axis A1 in the chuck assembly 10, and an inner side 124 facing the axis A1 in the chuck assembly 10. As previously mentioned, each jaw 100 comprises a groove 128 extending at least partially in a direction parallel to the axis A1 and along the first radial side 112, the inner side 124, and the second radial side 116. In other embodiments, the groove 128 may be provided on at least one of the first radial side 112, the inner side 124, and the second radial side 116. As best illustrated in FIGS. 15A and 15B, the groove 128 has a length L1, which, in the chuck assembly 10 extends in a direction parallel to the axis A1.

With continued reference to FIGS. 12-16B, the outer side 120 of the jaw 100 is provided with threads 132 configured to engage the tightening sleeve. Upon rotation of the tightening sleeve, the threads 132 may engage (i.e., be pressed against) corresponding threads of the tightening sleeve to urge the jaws 100 between the deployed (FIG. 1) and the retracted positions (FIG. 2). In the illustrated embodiment (e.g., FIGS. 12, 15A), the threads 132 are provided adjacent the tool end 108 of the jaw 100. The tool end 108 of the illustrated jaw 100 is angled relative to the tip end 104. The tool end 108 can thus be passed along the axes A2 at the angles A3 through the passageways 18, while the tip end 104 can remain generally parallel to the axis A1 (See e.g., FIGS. 8, 9). FIGS. 12 and 15A-16B each illustrate that the groove 128 is located between the tip end 104 and the tool end 108 with the groove in communication with the threads 132. Other configurations of the groove 128 may be possible.

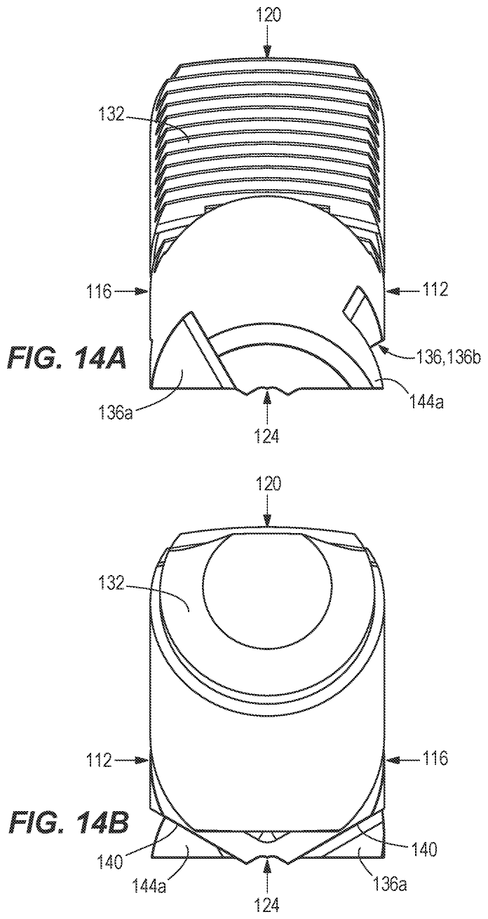

With continued reference to FIGS. 12-16B, the illustrated jaw 100 has a mating feature 136 thereon between the tip end 104 and the tool end 108. The illustrated jaw 100 includes the mating feature 136 on both the first radial side 112 and the second radial side 116. The mating feature 136 of one jaw 100 (e.g., the jaw 100a) is configured to mate with the mating feature 136 of an adjacent jaw 100 (e.g., the jaw 100b). As illustrated in FIG. 14B, the tip end 104 has, at the inner side 124, a planar inner surface 140. This planar inner surface 140 is also illustrated in FIG. 5, and extends generally parallel to the axis A1 from the mating feature 136 towards the tool end 108 before being interrupted by the channel 128.

As illustrated in FIG. 13, the mating feature 136 on the second radial side 116 is a male wedge-shaped protrusion 136a extending radially outwardly from the planar inner surface 140. As illustrated in FIG. 12, the mating feature 136 on the first radial side 112 is a female wedge-shaped cutout 136b extending radially inwardly from the planar inner surface 140. Otherwise shaped mating features 136 may also be used. For example, the mating features 136 may be square-shaped, triangle-shaped, rounded, semi-circular-shaped, irregularly-shaped, and the like. As best illustrated in FIG. 5, the jaws 100 include adjacent jaws 100 (e.g., the jaws 100a, 100b, and 100c) with alternating mating features 136. In the illustrated embodiment, the alternating mating features 136 include alternating male and female wedge-shaped protrusions and cutouts 136a, 136b circumferentially about the axis A1.

Accordingly, the male wedge-shaped protrusion 136a may be received with a corresponding adjacent female wedge-shaped cutout 136b when the chuck assembly 10 is located in the deployed position (FIG. 1). As best illustrated in FIGS. 15A and 15B, the male wedge-shaped protrusion 136a extends a length L2 between the tip end 104 and the tool end 108, and the female wedge-shaped cutout extends a length L3 between the tip end 104 and the tool end 108. The length L3 is slightly larger than the length L2 to permit receipt of the male wedge-shaped protrusion 136a within the female wedge-shaped cutout 136b. The mating features 136 may inhibit axial misalignment of the jaws 100 with respect to one another. In turn, this may promote centering of tool bits.

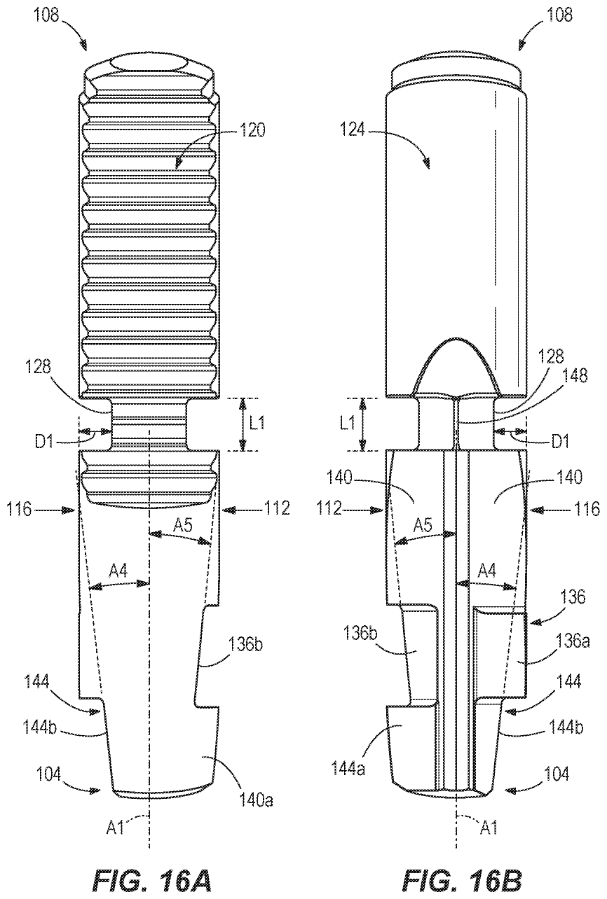

With reference to FIGS. 16A and 16B, the tip end 104 of the jaw 100 includes a mating element 144. This mating element 144 is located axially between the mating feature 136 and the tip end 104. Adjacent the first radial side 112, the mating element 144 is a male wedge-shaped protrusion 144a extending radially outwardly from the planar surface 140 (FIG. 16B). Adjacent the second radial side 116, the mating element 144 is a female wedge-shaped cutout 144b extending radially inwardly from the planar inner surface 140. As with the mating features 136, the jaws 100 include mating elements 144, which, in the chuck assembly 10 (FIG. 1) alternate circumferentially about the axis A1. Similar to the mating features 136, otherwise shaped mating elements 144 may also be used.

As best shown in FIG. 16B, the jaw 100 may also include both the mating feature 136 and the mating element 144. The illustrated jaw 100 alternates in an axial direction (i.e., along the axis A1) between the female wedge-shaped cutout 144b and the male wedge-shaped projection 136a on one side of the axis A1, and between the male wedge-shaped projection 144a and the female wedge-shaped cutout 136b on the other side of the axis A1. Accordingly, in the chuck assembly 10, interconnection between the mating features 136 and mating elements 144 may be enhanced. Other arrangements are possible. For example, one side of the axis A1 may be provided with male projections of differing radial projection amounts, and the other side of the axis A1 may be provided with corresponding female cutouts of differing radial cutout amounts.

As best illustrated in FIG. 16A, the female wedge-shaped cutout 144b is angled at an angle A4 relative to the axis A1. The angle A4 of the female wedge-shaped cutout 144b may promote centering of tool bits TB (FIG. 9) about the axis A1. As the tool bit TB (FIG. 9) is translated along the axis A1, the tool bit TB may contact the female wedge-shaped cutout 144b, and may be directed by the angle A4 to align with the axis A1. The female wedge-shaped cutout 136b may is also angled at an angle A5 relative to the axis A1. The tool bit TB may be, for example, a drill bit, a tool accessory, or any other type of component to be secured to the chuck assembly 10 for rotation therewith.

With reference to FIG. 16B, the groove 128 may be generally v-shaped, with an apex 148 of the v-shape being located adjacent the inner side 124 of the jaw 100. As previously mentioned, the groove 128 includes a length L1 extending generally parallel to the axis A1. The groove 128 further includes a depth D1 extending generally perpendicular to the axis A1 and towards the center of the jaw 100. The groove 128 is generally dimensioned to receive the notch 204 of the plate 200.

FIGS. 17 and 18 illustrate the plate 200 alone. The plate 200 includes the notches 204a, 204b, 204c and a hole 208. The hole 208 extends along the axis A1 in the chuck assembly 10. The hole 208 includes a chamfer 212. As illustrated in FIG. 9, the set screw 216 engages the hole 208. As a tool bit TB (FIG. 9) is translated in a direction along an offset axis OA parallel to the axis A1 towards the plate 200, the chamfer 212 may abut an end of the tool bit TB to align the tool bit TB along the axis A1. In some embodiments, the tool bit TB may include a chamfered end CE. The chamfered end CE may be seated within the chamfer 212. The plate 200 itself may also serve as an axial stop for the tool bit TB, inhibiting insertion of the tool bit TB into the chuck body 14 beyond the plate 200. Returning to FIGS. 16 and 17, the notches 204a, 204b, 204c (i.e., the notches 204) may be generally v-shaped with an apex 220 of the v-shape being located adjacent the axis A1. The plate 200 extends a length L2 extending generally parallel to the axis A1. The length L2 generally corresponds with the length L1 (FIG. 10). The length L2 also generally corresponds with the depth D1 of the groove 128. Accordingly, the notches 204 are dimensioned such that the groove 128 of the jaw 100 can be received within the notch 204.

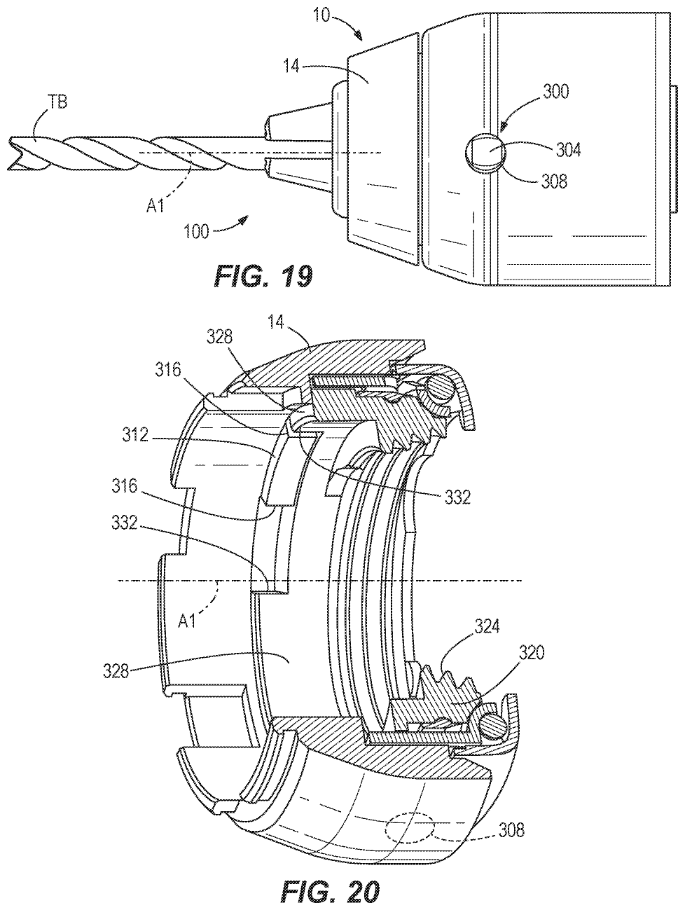

FIGS. 19-22 illustrate a lock indicator mechanism 300 for use with the chuck assembly 10 or other chuck assemblies. With reference to FIG. 19, the lock indicator mechanism 300 includes an indicator 304 (i.e., a lock indicator 304) for signifying the status of the jaws 100 on the tool bit TB. In the illustrated embodiment, the indicator 304 is a visual indicator which indicates locked and unlocked status of the jaws 100 upon the tool bit TB. The chuck body 14 includes a bore 308 through which a user may view the indicator 304. For example, the indicator 304 may change colors from a first color (e.g., red) when the jaws 100 are unlocked to a second color (e.g., blue) when the jaws 100 are locked. Alternatively, the indicator 304 may be an LED or other small light that illuminates when the jaws 100 are locked. Additionally or alternatively, the indicator 304 may present another visible indication when the jaws 100 are unlocked or do not have sufficient (i.e., do not meet a threshold) tension upon the tool bit TB. Accordingly, a user can view the indicator 304 through the bore 308 to determine whether the tool bit TB is adequately secured (i.e., locked) to the jaws 100. If the tool bit TB is adequately secured to the jaws 100, the user may operate the rotary power tool (e.g., the drill/driver). If the tool bit TB is not adequately secured the jaws 100, the user may adjust the connection between the jaws 100 and the tool bit TB prior to operating the rotary power tool (e.g., the drill/driver).

With reference to FIG. 20, the interior of the chuck body 14 is provided with a plurality of annular shoulders 312 radially spaced from one another. Each of the annular shoulders 312 has radial end walls 316. The lock indicator mechanism 300 further includes a barrel 320. The barrel 320 is positioned radially within the chuck body 14. The barrel 320 includes threads 324 which may engage the jaws 100. The barrel 320 further includes annular steps 328 radially spaced from one another. Each of the annular steps 328 has end walls 332. Upon rotation of the chuck body 14 where the jaws 100 freely rotate without contacting the tool bit TB, the end wall 332 of the step 328 abuts the end wall 316 of the shoulder 312. In this position, the tool bit TB is considered to be unlocked relative to the jaws 100.

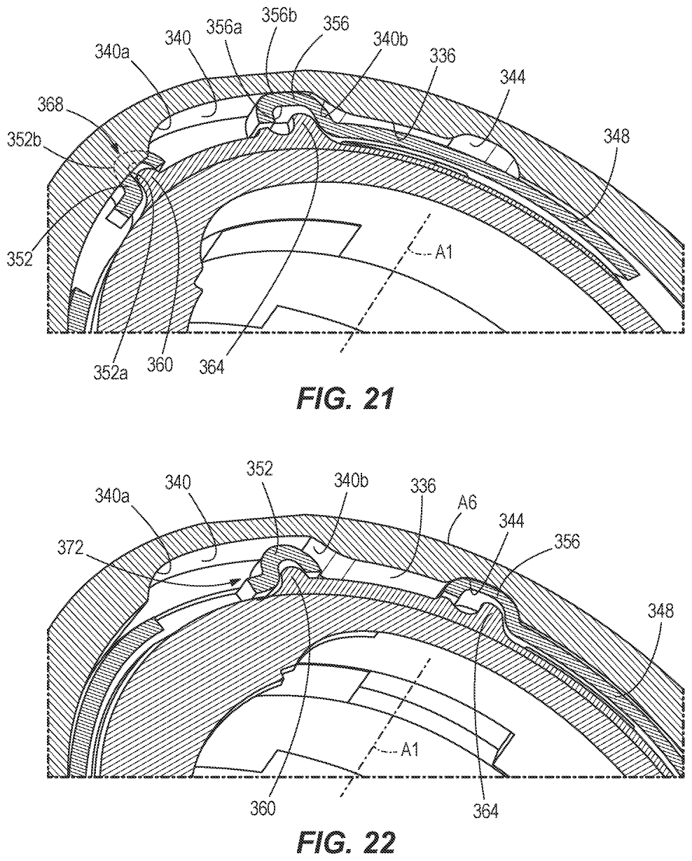

As shown in FIG. 21, the chuck body 14 includes an annular sidewall 336, a first recess 340, and a second recess 344. Both the first recess 340 and the second recess 344 extend radially outwardly from the annular sidewall 336 and away from the axis A1. The first recess 340 includes a first radial end 340a and an opposite second radial end 340b. The second recess 344 is closer to the second radial end 340b than the first radial end 340a. The lock indicator mechanism 300 includes a lock spring 348 positioned radially between the chuck body 14 and the barrel 320. The first recess 340 and the second recess 344 are each dimensioned to engage the lock spring 348. The lock spring 348 includes a first pawl 352 and a second pawl 356. The first pawl 352 and the second pawl 356 each extend radially outwardly from the remainder of the lock spring 348. The first pawl 352 and the second pawl 356 each include a radially inner surface 352a, 356a and a radially outer surface 352b, 356b. The radially outer surface 352b, 356b of each of the first pawl 352 and the second pawl 356 abuts the chuck body 14. The barrel 320 includes a first projection 360 and a second projection 364. The first projection 360 and the second projection 364 extend radially outwardly from the generally annular barrel 320. The first projection 360 and the second projection 364 are received by the radially inner surface of the first pawl 352, and the second pawl 356, respectively.

FIGS. 21 and 22 illustrate the lock indicator mechanism 300 in unlocked and locked positions, respectively. In the unlocked position of FIG. 21, the barrel 320 is positioned with the second pawl 356 being adjacent the second end 340b of the first recess 340. Additionally, in the unlocked position, the first pawl 352 is located adjacent the first end 340a of the first recess 340. The bore 308 is positioned in the chuck body 14 such that a user may view the first recess 340. In the unlocked position, the first pawl 352 is biased radially inward by an interface 368 between the first end 340a of the first recess 340 and the first pawl 352. This radially inward bias inhibits ratcheting engagement between the lock spring 348 and the chuck body 14.

Upon further rotation of the chuck body 14 in a direction securing the jaws 100 to the tool bit TB, the lock indicator mechanism 300 is transitioned from the unlocked position (FIG. 21) to the locked position (FIG. 22). To achieve this transition, a threshold rotating force upon the chuck body 14 is applied. During this transition, a number of actions occur within the lock indicator mechanism 300. First, the second pawl 356 is pressed radially inwardly and rotated in the radial direction about the axis A1 and along an arrow A6 to the second recess 344. Second, the first pawl 352 is rotated in the radial direction about the axis A1 and along the arrow A6 to the second end 340b of the first recess 340. Third, the end wall 332 of the step 328 is removed from and is rotated away from the end wall 316 of the shoulder 312. Finally, as the bore 308 permits a user to view the first recess 340, the user may witness the transition of the lock spring 348. Accordingly, in the embodiment illustrated in FIGS. 20-22, the lock spring 348 may be considered the indicator 304. The lock spring 348 may be colored or otherwise coated to be highly visible to a user. Upon completion of the transition, a threshold tensile force corresponding to the threshold rotating force secures the jaws 100 to the tool bit TB, and the tool bit TB is considered to be locked relative to the jaws 100.

FIG. 22 illustrates the locked position. In the locked position, the first pawl 352 is biased radially inward by an interface 372 between the second end 340b of the first recess 340 and the first pawl 352. This radially inward bias inhibits ratcheting engagement between the lock spring 348 and the chuck body 14.

A reverse operation to jaws 100 from the locked position to the unlocked position may be conducted in reverse. The bore 308 will also permit a user to witness the reverse operation.

The lock indicator mechanism 300 may include, additionally or alternatively, other means of indicating to a user the status of the jaws 100 on the tool bit TB. For example, the lock indicator mechanism 300 may include, in addition to or in replacement of the indicator 304, an audible indicator which emits a sound when the jaws 100 are locked and/or unlocked. For example, such an audible indicator may be generated by a speaker or may be otherwise generated by components contacting each other.

In another example, the lock indicator mechanism 300 may include, in addition to or in replacement of the indicator 304, a tactile indicator which transmits an indication to a user by the user's perception of touch to indicate when the jaws 100 are locked and/or unlocked. Such a tactile indicator may include, for example, a vibration or a ratcheting type mechanism capable of generating a tactile impulse. In some embodiments, the lock indicator mechanism 300 may emit a click when the jaws 100 are locked, which provides both an audible indication and a tactile indication to a user.

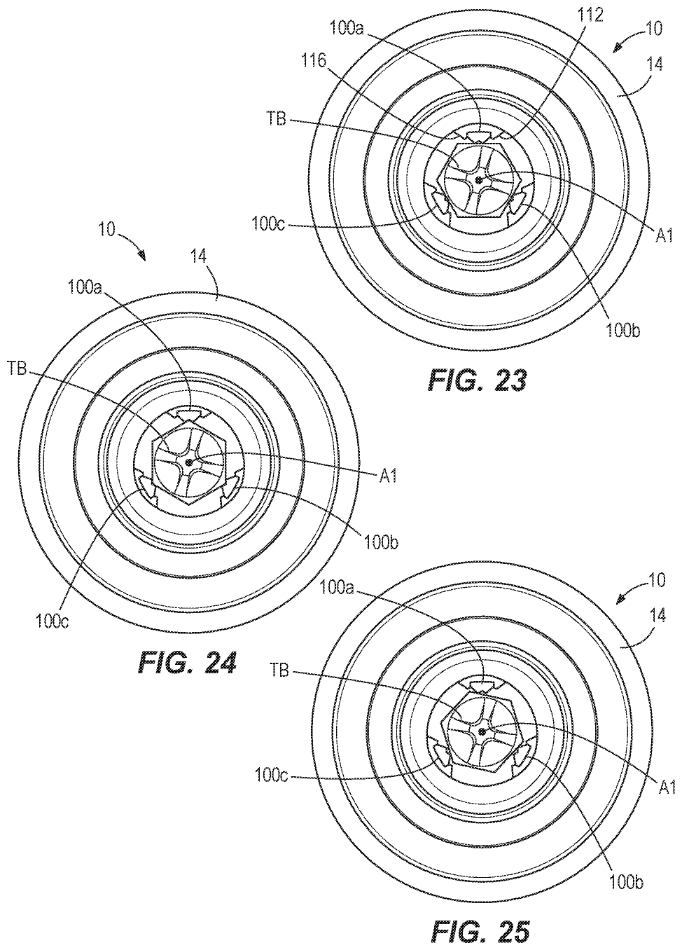

FIG. 23 illustrates a hexagonal tool bit TB inserted into a chuck assembly 10 with the tool bit TB properly engaged by the jaws 100. The surfaces of the hexagonal tool bit TB are aligned with the jaws 100 of the chuck assembly 10. FIG. 24 illustrates the hexagonal tool bit TB inserted into the chuck assembly 10 with the tool bit TB improperly engaged by the jaws 100. The edges of the hexagonal tool bit TB are engaged by the jaws 100. Upon rotation of the chuck assembly 10 as illustrated in FIG. 25, the jaws 100 will inevitably slip out of engagement with the edges of the hexagonal tool bit TB. Subsequently, force applied to the chuck assembly 10 and the jaws 100 may not be fully transmitted to the tool bit TB, leading to tool inefficiencies. Another outcome may be that the tool bit TB is damaged by the jaws 100.

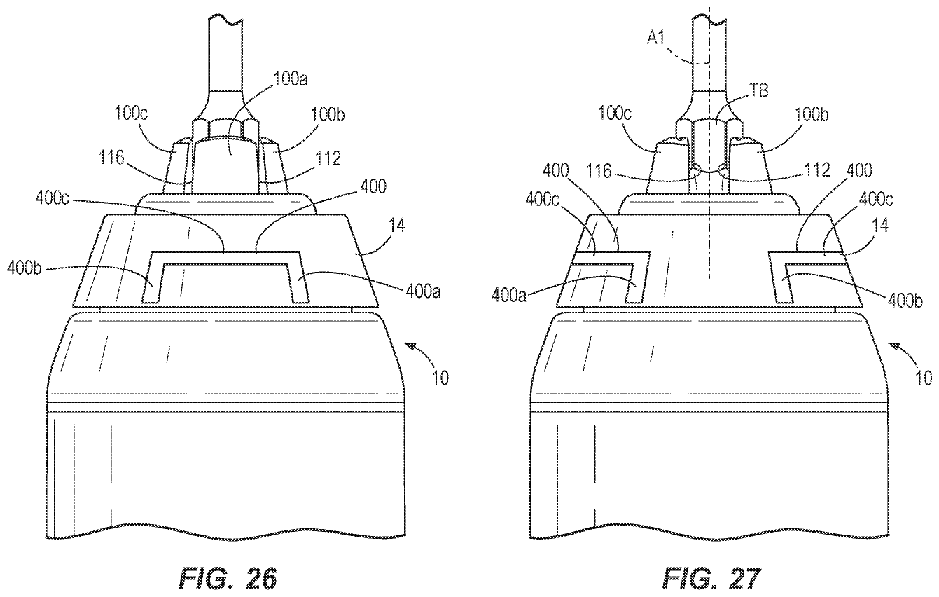

FIGS. 26-28 illustrate a jaw indicator 400 to provide a user an indication of the first radial side 112 and the second radial side 116 of each jaw 100. With knowledge of the location of the radial sides 112, 116 of each jaw 100, the user can insert the tool bit TB more accurately into the chuck assembly 10. This may promote insertion of the tool bit TB to properly engage the jaws 100 as illustrated in FIG. 23. The illustrated jaw indicator 400 is provided on the exterior of the chuck body 14. The illustrated jaw indicator 400 is differently colored than the remainder of the chuck body 14. Other such jaw indicators 400 may include markings, engravings, etchings, raised ridges, or other visible indicia upon the chuck body 14 or the tool body.

The illustrated jaw indicator 400 is provided for each of the jaws 100a, 100b, 100c, and includes generally axially extending component 400a, 400b for each of the radial sides 112, 116 of each of the jaws 100a, 100b, 100c. The illustrated jaw indicator 400 further includes a generally circumferentially extending component 400c which connects the two generally axially extending surfaces 400a, 400b which correspond to the radial sides 112, 116 of a single jaw (e.g., 100a). The circumferentially extending component 400c may communicate to a user how the flat surfaces of the tool bit TB should be inserted into the shuck assembly 10 to properly secure the tool bit TB to the jaws 100 as viewed in FIG. 23. As best illustrated in FIG. 28, reference lines RL1, RL2 extending along the axially extending components 400a, 400b of the jaw indicator 400 extend towards the axis A1, and extend tangent to the radial sides 112, 116 of the jaw 100a.

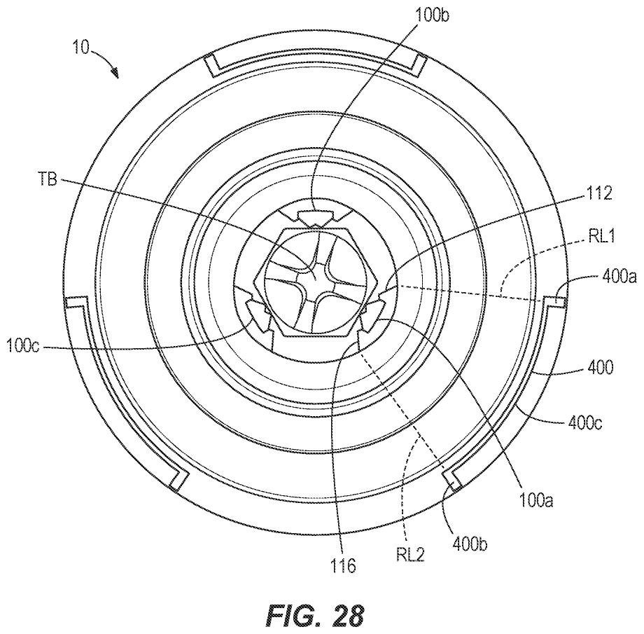

FIGS. 26 and 27 illustrate the jaws 100 as protruding axially beyond the bounds of the chuck body 14. The jaw indicator 400 is particularly useful when the jaws 100 are retracted within the chuck body 14 and are not themselves visible from the exterior of the chuck assembly 10. With the jaw indicator 400 applied to the chuck body 14, a user can know the radial position of the jaws 100 about the axis A1 even while the jaws 100 do not protrude from the chuck body 14.

Although the invention has been described in detail with reference to certain preferred embodiments, variations and modifications exist within the scope and spirit of one or more independent aspects of the invention as described.

Various features and advantages of the invention are set forth in the following claims.

1. A chuck assembly for use with a rotary power tool to secure a tool bit to the rotary power tool, the chuck assembly comprising:
a chuck body rotatable about an axis, the chuck body including a plurality of passageways;
a plurality of jaws:
each received within one of the plurality of passageways for co-rotation with the chuck body about the axis,
each comprising a tip end and an opposite tool end, a first radial side and an opposite second radial side, an outer side and an opposite inner side, the inner side facing the axis, and
each comprising a groove extending in a direction perpendicular to the axis and along the first radial side, the inner side, and the second radial side; and
a plate comprising a plurality of notches, each notch receiving the groove of one of the plurality of jaws to couple the plate to the plurality of jaws, the plate moving with the plurality of jaws to set an axial stop for the tool bit.

2. The chuck assembly of claim 1, wherein each of the plurality of passageways is angled relative to the axis.

3. The chuck assembly of claim 1, wherein the jaws are movable along the passageways between a deployed position, in which the jaws are axially forward and radially inward with regard to the axis, and a retracted position, in which the jaws are axially rearward and radially outward with regard to the axis.

4. The chuck assembly of claim 3, further comprising a barrel having barrel threads, wherein the outer sides of the jaws include threads which engage the barrel threads, and wherein movement of the barrel causes corresponding movement of the jaws between the deployed position and the retracted position.

5. The chuck assembly of claim 1, wherein the groove of each of the plurality of jaws is v-shaped and includes, at the inner side, an apex, and wherein each notch is v-shaped and includes, adjacent the axis, an apex configured to receive the apex of a corresponding groove.

6. The chuck assembly of claim 1, wherein the notches are dimensioned such that the groove of each jaw can be received within a corresponding notch.

7. A chuck assembly for use with a rotary power tool to secure a tool bit to the rotary power tool, the chuck assembly comprising:
a chuck body rotatable about an axis, the chuck body including a plurality of passageways; and
a plurality of jaws:
each received within one of the plurality of passageways for co-rotation with the chuck body about the axis,
each comprising a tip end and an opposite tool end, a first radial side and an opposite second radial side, an outer side and an opposite inner side, the inner side facing the axis, and
each comprising a mating feature configured to mate with the mating feature of an adjacent one of the plurality of jaws.

8. The chuck assembly of claim 7, wherein the mating feature of each jaw is positioned between the tip end and the tool end.

9. The chuck assembly of claim 7, wherein the mating feature of each jaw includes a male wedge-shaped protrusion extending radially outwardly from a planar inner surface of the jaw, the planar surface facing the inner side of the jaw.

10. The chuck assembly of claim 9, wherein the mating feature of each jaw further includes a female wedge-shaped cutout extending radially inwardly from the planar inner surface of the jaw.

11. The chuck assembly of claim 10, wherein the female wedge-shaped cutout of each jaw is dimensioned to receive a male wedge-shaped protrusion of the adjacent one of the plurality of jaws.

12. The chuck assembly of claim 7, wherein the mating feature of each jaw includes a male wedge-shaped protrusion and a female wedge-shaped cutout;
wherein the male wedge-shaped protrusion of each jaw extends radially outwardly from a planar inner surface of the jaw at the first radial side of the jaw, the planar surface facing the inner side of the jaw; and
wherein the female wedge-shaped cutout of each jaw extends radially inwardly from the planar inner surface of the jaw at the second radial side of the jaw.

13. The chuck assembly of claim 7, wherein the mating feature of each jaw is angled relative to the axis.

14. The chuck assembly of claim 7, wherein the mating feature of each jaw is a first mating feature on the first radial side, and wherein each jaw includes a second mating feature on the second radial side.

15. The chuck assembly of claim 7, wherein the mating feature of each jaw is angled relative to the axis and is configured to mate with the mating feature of an adjacent one of the plurality of jaws.

16. The chuck assembly of claim 7, wherein the mating feature of each jaw is positioned adjacent the tip end.

17.-21. (canceled)

22. A chuck assembly for use with a rotary power tool to secure a tool bit to the rotary power tool, the chuck assembly comprising:
a chuck body rotatable about an axis, the chuck body including a plurality of passageways;
a plurality of jaws:
each received within one of the plurality of passageways for co-rotation with the chuck body about the axis, and
each comprising a tip end and an opposite tool end, a first radial side and an opposite second radial side, an outer side and an opposite inner side, the inner side facing the axis; and
an indicator configured to indicate to a user locations the plurality of jaws.

23. The chuck assembly of claim 22, wherein the locations of the jaws correspond with radial positions of the plurality of jaws about the axis.

24. The chuck assembly of claim 22, wherein the indicator is configured to indicate to the user locations of the first radial side and the second radial side of the plurality of jaws.

25. The chuck assembly of claim 22, wherein the indicator is provided on an exterior surface of the chuck body.

26. The chuck assembly of claim 22, wherein the indicator includes a pair of axially extending components each corresponding with one of the radial sides of one of the jaws.

27. The chuck assembly of claim 26, wherein the indicator includes a circumferentially extending component connecting adjacent axially extending components.

28. The chuck assembly of claim 26, wherein a reference line extending through the axially extending component is tangent to one of the radial sides of one of the jaws.
